(19) United States
(12) Patent Application Publication
(10) Pub. No.: US 2025/0062551 A1
(43) Pub. Date: Feb. 20, 2025

(54) Plug-in connector and arrangement comprising a plug-in connector and a stacking plate of an electrolyzer

(71) Applicant: Weidmüller Interface GmbH & Co. KG, Detmold (DE)

(72) Inventors: Jan MEIER, Detmold (DE); Marcel MAINKA, Lage (DE); Karlo STJEPANOVIC, Bielefeld (DE); Thomas WIELSCH, Detmold (DE); Torsten JUNG, Horn-Bad Meinberg (DE); Jasper SCHREIBER, Lage (DE); Matthias KASPAR, Porta Westfalica (DE); Michael HERRMANN, Detmold (DE)

(21) Appl. No.: 18/772,402

(22) Filed: Jul. 15, 2024

(30) Foreign Application Priority Data
Aug. 17, 2023 (DE) 20 2023 104 663.0

(51) Int. Cl. H01R 4/70; C25B 9/65; H01M 8/0247; H01M 8/04664; H01M 8/2465; H01R 4/48; H01R 4/58

(52) U.S. Cl. CPC H01R 4/70; C25B 9/65; H01M 8/0247; H01M 8/04664; H01M 8/2465; H01R 4/48; H01R 4/58

(57) ABSTRACT

A plug-in connector for contact with a stacking plate of an electrolyzer includes a sheet-metal part having a tulip contact for contacting the stacking plate and a cladding made of a material which is dimensionally stable at 1000° C. A single cladding is allocated to each sheet-metal part, respectively, for contacting a single stacking plate.

This application claims priority of DE 20 2023104663.0 filed Aug. 17, 2023. The entire content of this application is incorporated herein by reference.

### BACKGROUND OF THE INVENTION

The present invention relates to a high-temperature plug-in connector and an assembly including a high-temperature plug-in connector and a stacking plate of an electrolyzer.

### BRIEF DESCRIPTION OF THE PRIOR ART

An electrolyzer typically has a number of membrane electrode units whose electrical outputs add up in the stack. A stacking plate, which is a core element of the electrolyzer, is arranged between two membrane electrode units of an electrolyzer stack, respectively. The stack can include several hundred stacking plates. During the manufacturing process, the stacking plate stack is baked using a high-temperature process with a high efficiency of more than 85% by applying a voltage in a hydrogen atmosphere at temperatures of far more than 700° C. As the temperature rises, the stack fuses together by up to 50% of its original height and an electrical short circuit can occur between the stacking plates. To avoid this, one or more conductors or plugs are arranged on the stacking plate. The stressed high-temperature plug-in connectors and conductors are used to tap the electrical potentials and thus monitor the functional unit. Defective stacking plates can thus be detected and bridged.

In the stack, this number of stacking plates fulfil the task of physically and electrically connecting the anode of one cell with the cathode of the adjacent cell. In addition, the stacking plate assumes the task of conducting reaction gases into the reaction zone. For this purpose, the respective plate can have flow-conducting profiles. A stacking plate substantially includes the two poles of a single electrolyzer with an anode plate as the negative pole and a cathode plate as the positive pole for supplying the reaction media. The plates enable the distribution and dissipation of thermal and electrical energy and are usually designed as metal plates. However, the stacking plates can also be made of graphite or a composite material.

DE 10 2016 115 100 A1 discloses a plug-in connector for a connection plate. The plug-in connector has a tulip contact with opposing spring legs. The plug-in connector is clamped to the surface of the connection plate. The disadvantage of this device is that the clamping forces change with increasing temperatures. In certain circumstances, this may result in the plug-in connector slipping or in interruption of the electrical contact due to relaxation and setting effects.

This can be counteracted by increasing the clamping forces of the tulip contact, e.g. by thickening the material in the area of the tulip contact, by molding the tulip shape more strongly, or by other geometric adjustments. However, this also increases the forces which have to be applied to fasten the plug-in connector. In addition, the forces are lost with increasing time and/or temperature due to relaxation processes.

At operating temperatures between 950-1000° C., the plug-in connector may fuse to the stacking plate and a gap dimension may be lost. Prior to this, the spring force of the plug-in connector decreases rapidly.

Furthermore, in the field of plug-in connectors it is common practice to enclose several plug-in connectors in a common connector housing. This is depicted in FIG. 1 of DE 10 2016 115 100 A1, but also in DE 10 2013 206 129 A1 and in DE 10 2014 225 949 A1. This has the disadvantage that if one plug-in connector fails, the entire plug assembly installed in the plug must be replaced. Moreover, the assembly in series allows less flexibility with several plug-in spaces available on the stacking plate.

### SUMMARY OF THE INVENTION

Taking the aforementioned state of the art as a starting point, the present invention was developed to enable the connection between the plug-in connector and the stacking plate to be released in the case of partially hot components while at the same time allowing flexible selection between the available plug-in spaces.

Furthermore, the present invention provides a pluggable assembly made up of the plug-in connector and the stacking plate which ensures good retention when a temperature of over 700° C. develops in an electrolyzer and at the same time can be easily released with a moderate amount of force.

A plug-in connector according to the invention is used to make contact with a stacking plate. It includes a sheet-metal part with a tulip contact for making contact with the stacking plate and a cladding made of material which is dimensionally stable up to over 1000° C. The invention is characterized by the fact that one single cladding is allocated to one sheet-metal part, respectively, for contacting to a single stacking plate.

The aforementioned stacking plate can preferably be a metal plate. However, stacking plates made of graphite or a composite material are also possible.

The stacking plate is preferably a bipolar plate. These bipolar plates and plug-in connectors can also be used in fuel cells as an alternative to the electrolyzer.

This enables an offset assembly of the plug-in connectors on a number of possible plugging spaces along a stack of stacking plates and/or an exchange of an individual plug-in connector in the case of a defect.

The individual conductors of the stacking plates can be guided in a corresponding multiple plug-in connector which then provides a dielectric connection.

The cladding is preferably formed of a ceramic material, in particular a technical ceramic. The cladding preferably has a box-shaped outer contour, whereby the stackability and the space-saving assembly at the edge at a metal stack is particularly favorable. The cladding is preferably in one piece but can also be designed in several parts.

The cladding defines a storage space in which the sheet-metal part is arranged at least in sections. Furthermore, the cladding has a cavity for receiving a stacking plate section, in particular an edge web of a stacking plate. The receiving cavity has a greater width perpendicular to the plate plane of the sheet-metal part than the storage space. Especially with ceramic claddings, such spatial divisions are not trivial and are difficult to manufacture. The aforementioned spatial division creates an axial stop which, together with a counter-stop, allows the sheet-metal part to be fixed with respect to the cladding.

The cladding has an insertion slot for inserting a stacking plate, wherein the insertion slot is designed in such a manner that the stacking plate is gripped on both sides by the plug-in connector. As a result, better protection against contamination and at the same time optimized electrical insulation of the plug connection is achieved.

The insertion slot has a number of opening areas which are matched during assembly to a contour of the tulip contact. As a result, better protection against soiling and accidental damage is achieved.

For improved insulation, a central opening area has a molded depression on a first side of the plate plane of the plug-in connector and two adjacent opening areas each have a molded depression on the opposite second side of the plate plane.

For better guiding and enclosing, the cladding contains a feed-through on a side opposite the insertion slot for plugging in a terminal contact protrusion of the sheet-metal part when connecting the cladding to the sheet-metal part.

The cladding is connected by plugging the sheet-metal part to the plug-in connector. This mounting is comparatively simple and can be performed in an automated manner.

The plug-in connector is composed exclusively of two components, the sheet-metal part and the cladding. This simplifies the structural design of the plug-in connector.

The cladding is secured against axial displacement relative to the longitudinal axis of the plug-in connector by blocking wings, in particular by blocking wings arranged on the sheet-metal part.

Moreover, the cladding has an end face of the plug-in connector along which the insertion slot runs in sections. Since the end face terminates with the cladding, good protection from soiling or other environmental influences is guaranteed.

For better mounting, the plug-in connector has an insertion slope in the region of the end face.

Further in accordance with the invention, an assembly made up of a plug-in connector and a stacking plate for use in a fuel cell is provided. The plug-in connector has a tulip contact with contact wings. Moreover, the stacking plate has a window or a groove-shaped depression, wherein at least one contact wing of the tulip contact extends at least in sections into the window or into the depression in the stacking plate. As a result, a form-fit or force-fit can be achieved at points or over the entire surface.

A window defines an opening in the stacking plate, which is a preferred design due to the possibility of engaging or extending deeply into the window.

However, a form-fit by providing a depression is also possible within the framework of the invention so that the stacking plate has a closed surface.

For a particularly strong connection of the two components of the assembly, two contact wings of the tulip contact extend into the window or into the depression from different sides of the stacking plate.

Moreover, it is advantageous if three contact wings of the tulip contact extend into the window or the depression.

The plug-in connector can be locked onto the stacking plate through the assembly of the contact wings of the tulip contact in the window or the depression.

An edge web of the stacking plate is preferably locked between the contact wings of the tulip contact via prestressing.

The preferred minimal distance of the two contact wings in the prestress-free state can be between 0.4 to 0.8 mm, preferably 0.5 to 0.7 mm.

The preferred minimal spacing of the two contact wings can be between 100-300%, preferably 150-250%, of the plate thickness of the sheet-metal part.

Furthermore, the material of the contact wings, and preferably the material of an entire sheet-metal part with the tulip contact of a plug-in connector, is made of a chromium-nickel steel which is resistant to high temperatures, particularly of a Cr—Ni stainless steel.

The length of the connection interface between a contact wing of the tulip contact and an adjacent sheet-metal plate is less than 50%, preferably less than 40%, of the length of a separation slot between the contact wing and an adjacent contact wing.

Furthermore, the sheet-metal part of the plug-in connector has a terminal contact protrusion.

The contact protrusion has blocking wings for axially fixing a cladding to firmly secure the sheet-metal part with respect to the cladding.

The plug-in connector of the assembly is designed as an above-described plug-in connector according to the invention.

The blocking wings can be arranged above or below the plate plane of the sheet-metal plate to fix the cladding.

The preferred plate thickness of the sheet-metal part is more than 0.1 mm, preferably 0.2-0.4 mm.

The stacking plate has a material thickness of more than 0.5 mm, preferably 0.6-0.8 mm.

The contact wings have curves for locking onto the stacking plate which curves have radii of curvature which are arranged parallel and offset relative to one another along the longitudinal axis of the sheet-metal part.

Alternatively, the contact wings have curves for locking onto the stacking plate, wherein the curves have radii of curvature situated on an axis perpendicular to the plate plane.

### BRIEF DESCRIPTION OF THE FIGURES

Further advantages, features and details of the invention will become apparent from the following description, in which a number of exemplary embodiments of the invention will be explained in greater detail in connection with the accompanying drawing, in which:

FIG. 1 is a schematic perspective view of an assembly according to the invention;

FIG. 2 is a schematic perspective view of a plug-in connector as part of the assembly of FIG. 1;

FIG. 3 is an additional schematic perspective view of the assembly of FIG. 1;

FIG. 4 is a schematic perspective view of the plug-in connector of FIG. 2;

FIG. 5 is a plan view of the plug-in connector of FIGS. 2 and 4;

FIG. 6 is a front view of the plug-in connector of FIG. 5;

FIG. 7 is a side view onto the plug-in connector of FIG. 5 or 6;

FIG. 8 is an enlarged side view of a portion of the tulip contact of FIG. 7;

FIG. 9 is a side view of the assembly of FIG. 1;

FIG. 10 is an enlarged view of a portion of the tulip contact of FIG. 9;

FIG. 11 is a side view of a further embodiment of an assembly according to the invention;

FIG. 12 is an enlarged side view of a portion of the tulip contact of FIG. 11;

FIG. 13 is a perspective view of the assembly of FIG. 1 with a cladding of the plug-in connector;

FIG. 14 is a perspective view of the plug-in connector of FIG. 2 with the cladding;

FIG. 15 is a plan view of the plug-in connector of FIG. 14;

FIG. 16 is a side view of the plug-in connector of FIGS. 14 and 15;

FIG. 17 is a front view of the plug-in connector of FIGS. 14-16;

FIG. 18 is a sectional view of the assembly of FIG. 13;

FIG. 19 is a plan view of the assembly from FIG. 13 and FIG. 18; and

FIG. 20 is a rear view of the assembly from FIG. 13 and FIGS. 18-19.

### DETAILED DESCRIPTION

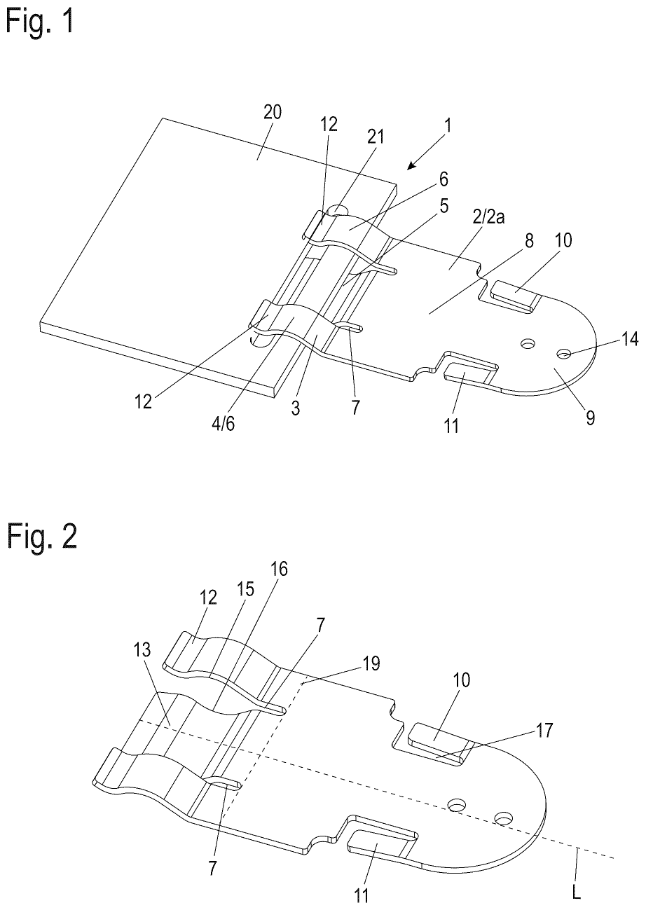

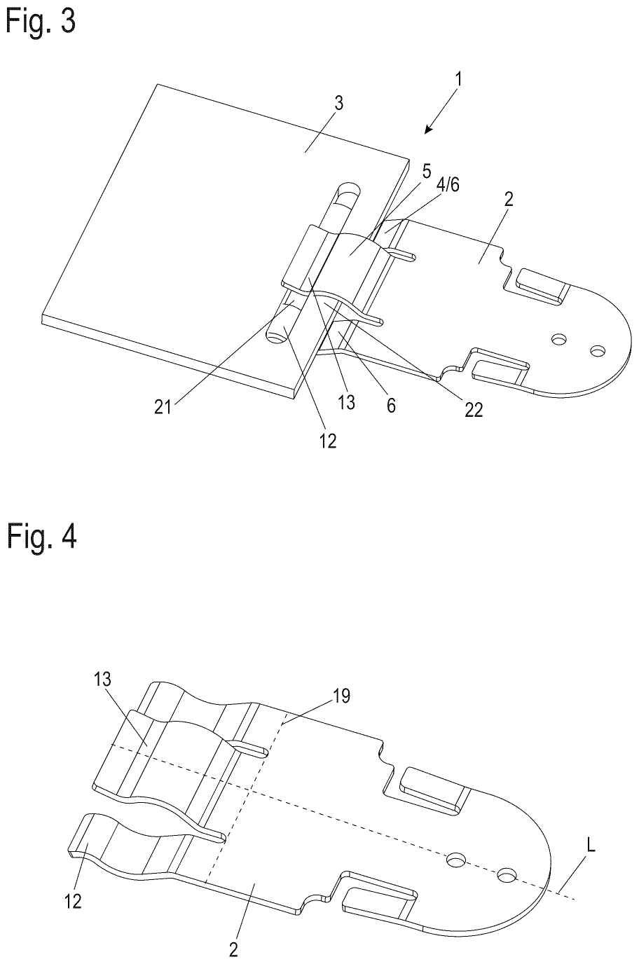

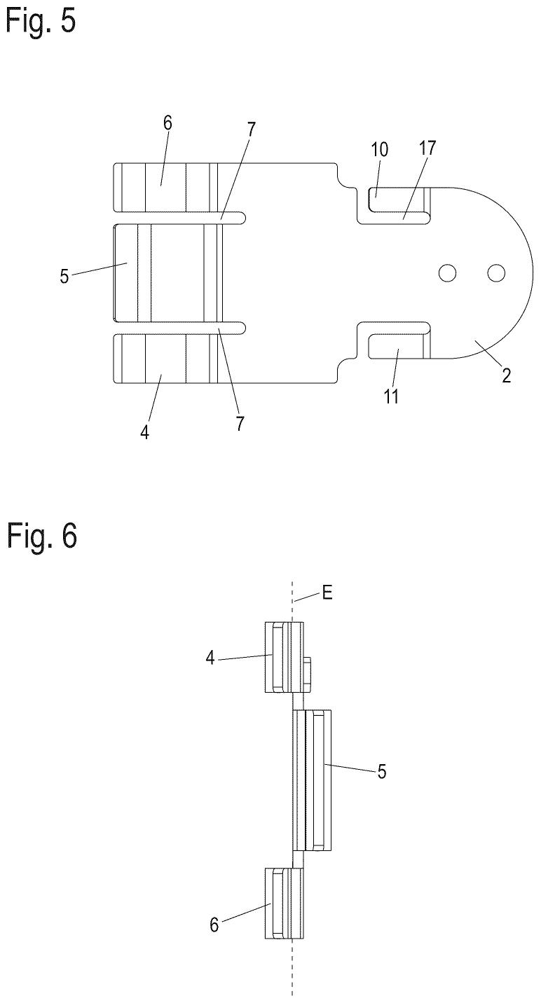

FIGS. 1, 3 and 9-12 show an assembly 1 according to the invention including a plug-in connector 2 and a stacking plate 3, preferably a metal plate, which are releasably connected to one another. The stacking plate is preferably a bipolar plate. The plug-in connector 2 formed as a sheet-metal part 2a is shown individually in FIGS. 2 and 4-8.

The plug-in connector 2 has a tulip contact 4 which possesses a total of three contact wings 5 and 6. A middle contact wing 5 is designed to be broader than the two adjacent edge-side contact wings 6.

The plug-in connector 2 is made of sheet metal and formed into its depicted shape by cutting and forming processes. The plug-in connector has a central sheet-metal plate 8 which defines a plate plane E.

The middle contact wing 5 is designed to be curved and protrudes in a first direction by a bulge 16 relative to a plate plane E.

The edge-side contact wings 6 arranged on both sides beside the contact wing 5 have one bulge 15 each which protrude in a second direction which is opposite the first direction relative to a plate plane E.

In the region between the bulges 15 and 16 of the contact wings 5 and 6, a bar-shaped or strip-shaped segment can be accommodated and retained, with pre-tensioning, at the level of the plate plane E.

The contact wings 5 and 6 are separated from one another by separation slots 7. The contact wings additionally have a connection interface 19 to the adjacent sheet-metal plate 8, which is defined as a line perpendicular to the longitudinal extent of the separation slots. In the case of the edge-side contact wings 6, this connection interface 19 extends from the protrusion of the separation slot 7 to the edge of the plug-in connector 2 perpendicular to the longitudinal axis L of the plug-in connector 2. In the case of the middle contact wing, the connection interface 19 is situated between the protrusions of the two separation slots 7. The length of the connection interface 19 is preferably less than 50%, particularly preferably less than 40%, of the length of the separation slot 7.

A conductor (not shown) is fixed in a contact protrusion 9 opposite the tulip contact 4, of the plug-in connector 2. In FIG. 1, the contact protrusion 9 has an anchoring point 14 in the form of two bores for receiving and fastening a conducting element of the conductor.

Furthermore, the contact protrusion 9 has two blocking wings 10, 11 for fixing a border against axial displacement along the longitudinal axis L of the plug-in connector 2. The blocking wings 10, 11 block the border by deforming out of the plate plane E. A separation slot 17 defines the length of the respective blocking wings 10 and 11 and separates each wing from the remaining regions of the plug-in connector.

The connecting or buckling region of the blocking wings 10, 11 relative to the remaining regions of the plug-in connector 2 extends over a smaller length than the separation slot 17, preferably less than half the length of the separation slot 17.

Adjacent to the bulges 15 and 16 of the contact wings 5 and 6, which bulges are directed away from the plate plane E, the contact wings each have curves 12, 13 directed towards the plate direction. The curves 12, 13 of two adjacent contact wings 5, 6 are thus offset relative to one another but are directed towards one another in the side view.

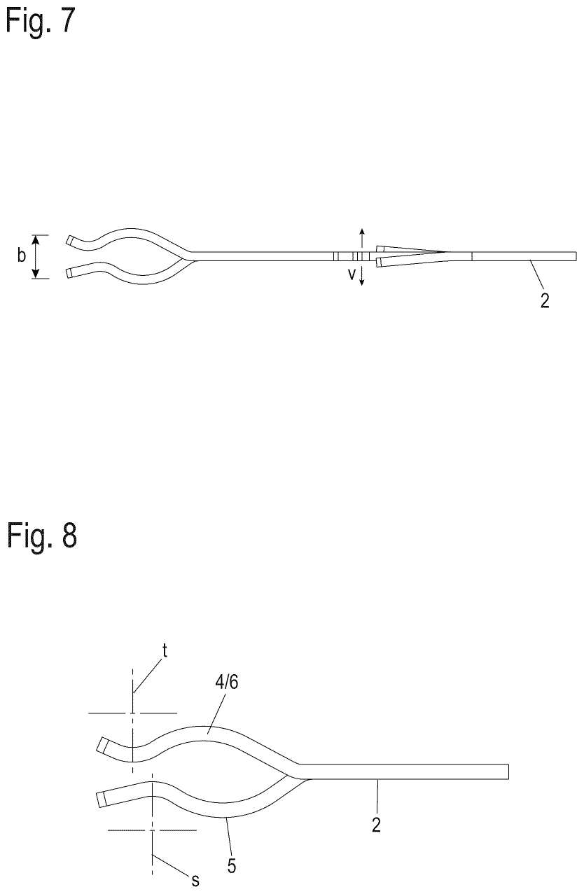

The spacing of two points of inflection of the curves 12 and 13 define an opening as a minimal prestress-free tulip spacing b as shown in FIG. 7 which can be enlarged by spreading the contact wings 5, 6 when plugging a stacking plate 3 into this opening to form a restoring force.

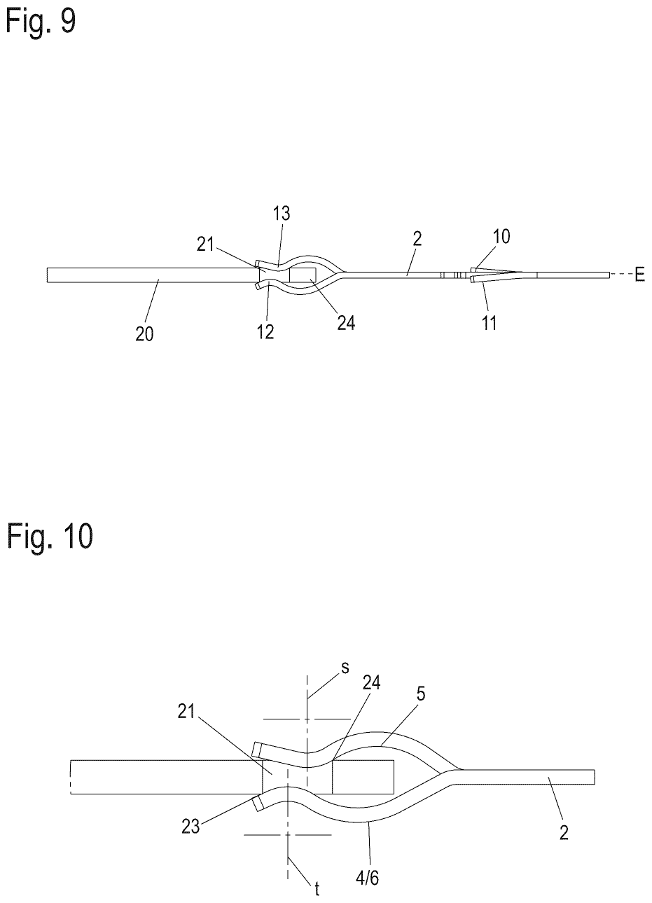

As can be seen from FIG. 1 or also FIGS. 9 and 10, the stacking plate, in a manner which differentiates it from the above-noted prior art, has a window 21 or groove in which the curves 12, 13 of the contact wings 5, 6 are arranged at least in certain areas.

A window refers to a breach or hole in the stacking plate, while a groove is designed as an elongated depression, with the stacking plate in this embodiment being designed as a closed plate without openings.

The window 21 is designed to be slot-shaped with a longitudinal extent that extends beyond the width of the plug-in connector 2 or at least beyond the width of the tulip contact 4 perpendicular to the longitudinal axis L of the plug-in connector 2.

As can be seen in FIGS. 9 and 10, the curves 12 and 13 of the contact wings 5 and 6 of the tulip contact 4 extend into the opening defined by the window 21.

As can be recognized in particular from FIG. 10, there are stop points 22 and 23 between a section of the curve 12 and 13 and the edge of the window 21.

In construction terms, the stop points block the relative movement of the plug-in connector 2 with respect to the stacking plate 3 in or against the plugging direction. Thus, the connection between the plug-in connector 2 and the stacking plate is a purely force-fitting connection, but also as a form-fitting connection.

On one side, the window 21 is bordered by an edge web 22 of the stacking plate 20 as shown in FIG. 2. The edge web 22 is located between the bulges 15 and 16 of the contact wings 5 and 6 of the tulip contact 4. Depending on the dimensions, the edge web can be held between the contact wings 5 under prestressing, or without prestressing.

Placing the contact wings 5, 6 in the window 21 brings about a significantly stronger connection than is the case with a pure force-fitting clamping assembly as shown in the prior art. Moreover, the plug-in connector 2 is prefixed by the dimensions of the window 21 with regard to its plugging position and is secured against twisting or other incorrect positioning relative to the stacking plate 3.

If excessive temperature stress leads to the plug-in connector 2 fusing together with the stacking plate 3, the window 21 allows material to be taken up without the material extending over the further surface of the stacking plate 3 and thus over the poles provided for reacting the fuel cells.

The contact wings 5, 6 are arranged asymmetrically in the window 21 for guiding and positioning the connector, especially in relation to tilting. The radii of curvature s, t and the points of inflection of the curves 12 and 13 are not situated opposite one another, but rather are offset from one another as shown in FIG. 10.

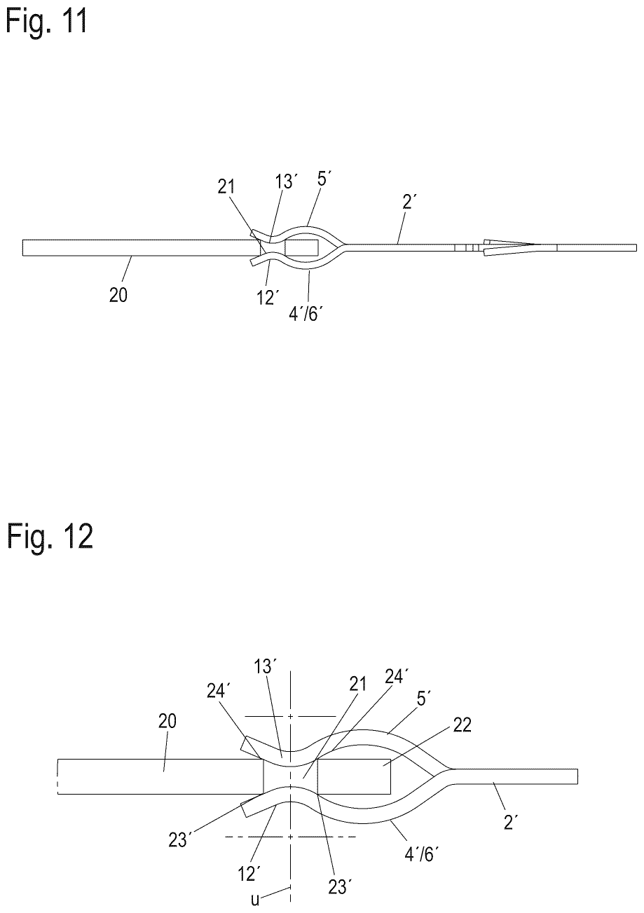

FIGS. 11 and 12 show an additional embodiment of a plug-in connector 2′ within the framework of the present invention, in which the points of inflection and radii of curvature u are arranged on an axis perpendicular to the plate plane E.

Accordingly, twice as many stop points 23′ and 24′ are provided between the tulip contact 4′ and the window 21 resulting in a corresponding distribution of force onto several stop points 23′ and 24′ of the two curves 12′ and 13′ of the contact wings 5′ and 6′. The force distribution onto several stop points equally blocks pushing and pulling effects in all directions.

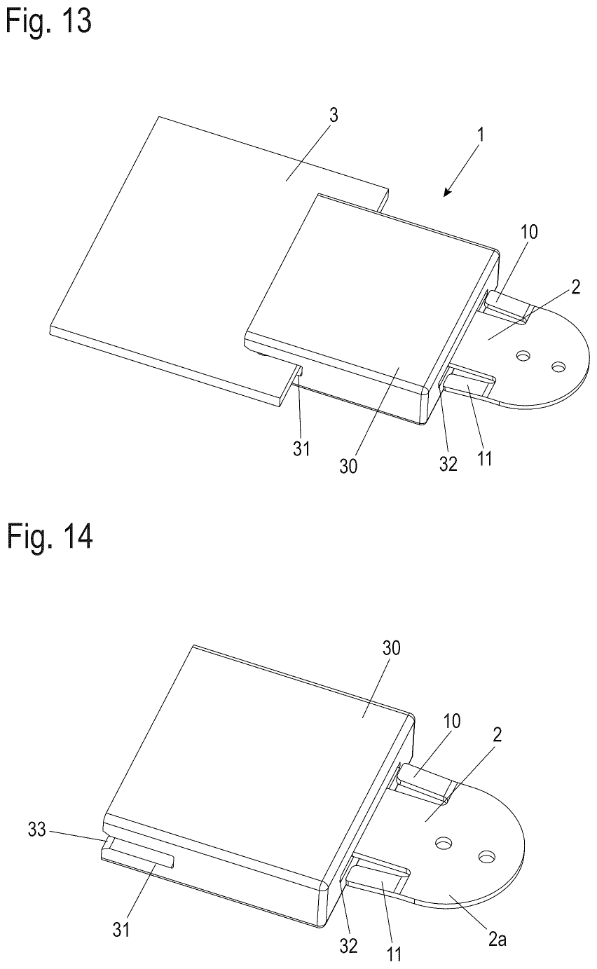

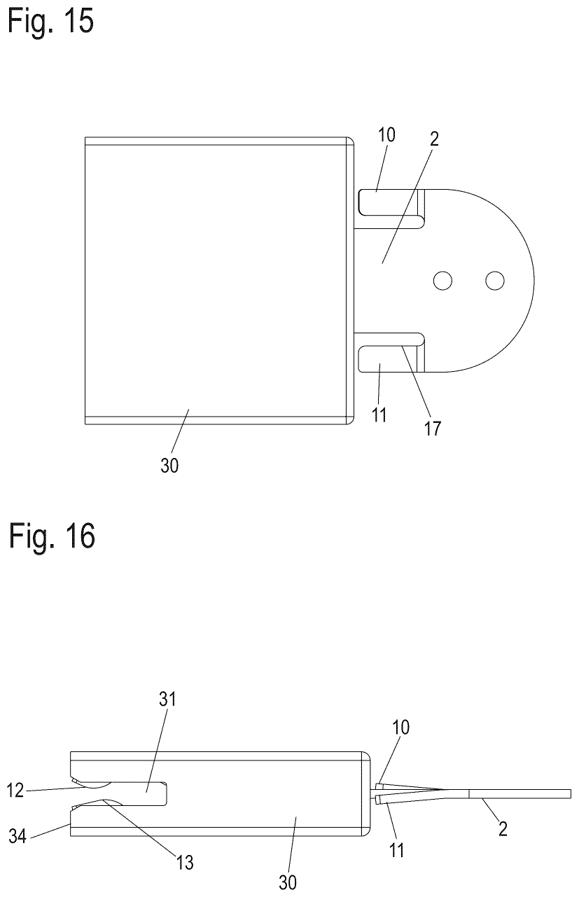

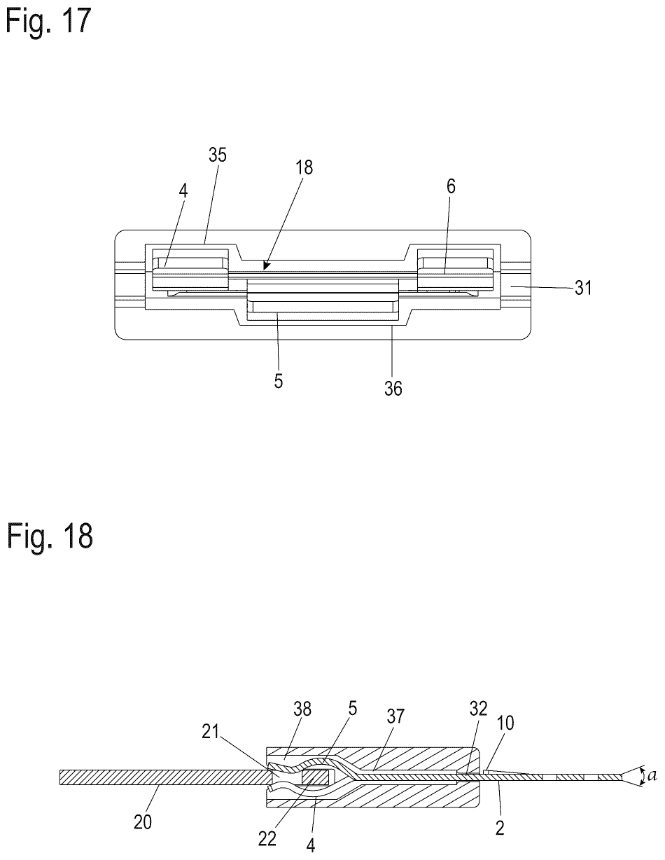

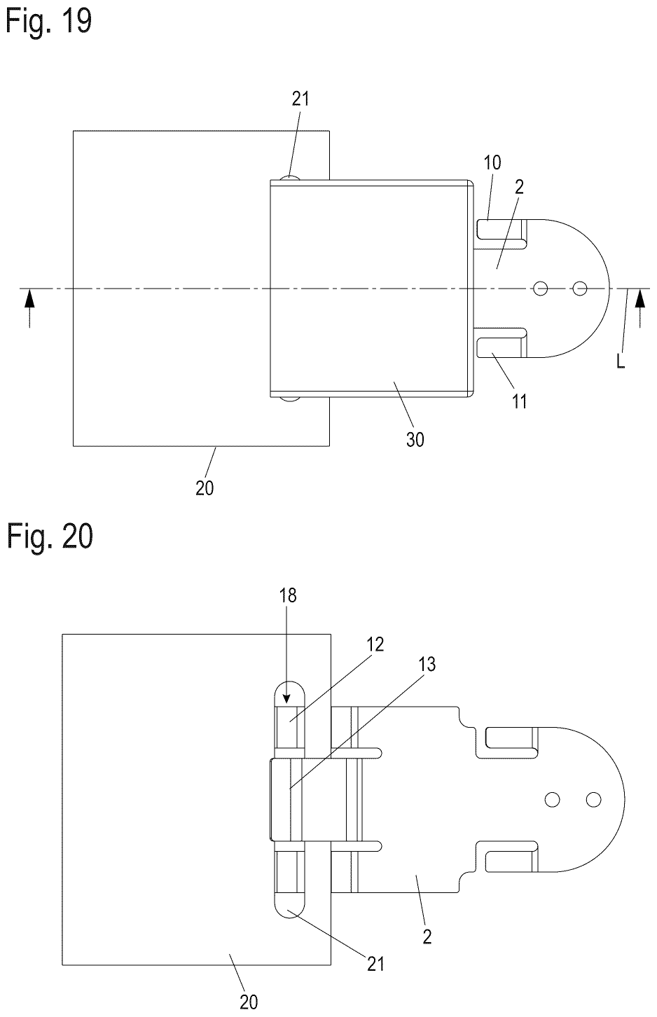

FIGS. 13-20 show a plug-in connector 2 according to the invention made of a sheet-metal part, analogous to FIGS. 1-12 and with an application-optimized border or cladding 30 and an assembly according to the invention realized with the plug-in connector 2.

The cladding 30 has a first edge containing an insertion slot 31 and an opposite edge containing a feed-through 32 for feeding the contact protrusion 9 through when mounting the cladding 30 on the remaining plug-in connector 2.

The cladding has a narrow zonal storage space 37 for retaining the sheet-metal plate 8, and a wider receiving cavity 38, perpendicular to the longitudinal axis L in relation to the storage space 37, for retaining the tulip contact 4 and possibly the edge web 22 of the stacking plate 20 fixed therein.

The insertion slot 31 extends over three edge regions of the cladding 30, so that the stacking plate 30 is gripped on both sides from below and above when it is placed in the insertion slot 31.

The cladding 30 has a greater wall thickness in the predominant area of the housing than the sheet thickness of the sheet-metal plate 8 of the plug-in connector 2. The insertion slot 31 is arranged on an end face 34 and has an insertion slope 33 starting from the end face.

The insertion slot 31 has a plurality of opening areas 35 and 36, which are matched to one another in such a way that they are matched to a contour profile of the tulip contact 4. A central opening area 36 has a molded depression on a first side of the plate plane E of the plug-in connector 2, and the two adjacent opening areas 35 each have a molded depression on the opposite second side of the plate plane.

The sheet-metal part 2a of the plug-in connector can be made of a chromium-nickel steel, in particular of a Cr—Ni stainless steel.

The preferred plate thickness a of the sheet-metal part 2a is more than 0.1 mm, preferably 0.2-0.4 mm.

The minimal distance of the two contact wings 5, 5′, 6, 6′ in the prestress-free state can be between 0.4 to 0.8 mm, preferably 0.5 to 0.7 mm.

The stacking plate 3 preferably has an average thickness of approximately 0.7 mm+/−0.1 mm.

The contact thickness of the contact wings 5 and 6 is preferably 0.3 mm+/−0.1 mm. The sheet-metal part 2a is preferably stamped from a metal sheet.

The connection between the plug-in connector 2 and the stacking plate 3 has the advantage that, when the spring force drops at high temperatures, locking between the two parts is maintained.

The cladding 30 offers protection against tilting of the sheet-metal part. The preferred material for the cladding is a ceramic, preferably a technical ceramic such as an aluminum oxide ceramic.

The cladding 30 has a box-shaped outer contour and can therefore be gripped with a robotic arm. The cladding is dimensionally stable up to over 1000° C., non-conductive and enables spacing and thus prevents neighboring plates from being placed on the stacking plate connected to the plug-in connector. After baking or heating of the stacking plate stack, the plug-in connector is able to move freely.

The cladding 30 completely covers the plugging face 18 of the plug-in connector 2. This serves as protection against bending or tilting of the tulip contact 4, 4′ and of the electrical insulation.

What is claimed is:

1. A plug-in connector for contact with a stacking plate, comprises
(a) a sheet-metal part having a tulip contact for contacting the stacking plate; and
(b) a cladding made of a material which is dimensionally stable at 1000° C., wherein one single cladding is allocated to one sheet-metal part, respectively, for contacting a single stacking plate.

2. The plug-in connector according to claim 1, wherein said cladding comprises a ceramic material.

3. The plug-in connector according to claim 1, wherein said cladding has a box-shaped outer contour.

4. The plug-in connector according to claim 1, wherein said cladding contains a storage space for zonally receiving said sheet-metal part and a receiving cavity for zonally accommodating a stacking plate section, wherein said receiving cavity has a greater width perpendicular to a plane of said sheet-metal part than said storage space.

5. The plug-in connector according to claim 1, wherein said cladding contains an insertion slot for inserting the stacking plate, wherein said insertion slot is configured to grip the stacking plate on both sides by the plug-in connector.

6. The plug-in connector according to claim 5, wherein said insertion slot contains a plurality of opening areas which are formed to match a contour profile of said tulip contact.

7. The plug-in connector according to any one of the preceding claims, characterized in that a central opening area (36) has a molded depression on a first side of the plate plane (E) of the plug-in connector (2) and two adjacent opening areas (35) each have a molded depression on the opposite second side of the plate plane (E).

8. The plug-in connector according to claim 5, wherein said cladding contains a feed-through in a side opposite to a side containing said insertion slot for plugging in a terminal contact protrusion of said sheet-metal part when connecting said cladding to said sheet-metal part.

9. The plug-in connector according to claim 1, wherein said cladding is connected by plugging in said sheet-metal part to the plug-in connector.

10. The plug-in connector according to claim 1 consisting of a maximum of two components, wherein said two components include said sheet-metal part and said cladding.

11. The plug-in connector according to claim 1, wherein said sheet-metal part has a longitudinal axis and includes blocking wings to secure said cladding against axial displacement relative to the longitudinal axis.

12. The plug-in connector according to claim 5, wherein said cladding has an end face which contains said insertion slot.

13. The plug-in connector according to claim 12, wherein said end face has an insertion slope adjacent to said insertion slot.

14. A plug-in assembly for use as a fuel cell, comprising
(a) a plug-in connector including a tulip contact having contact wings; and
(b) a stacking plate containing one of a window and a groove-shaped depression, wherein at least one contact wing of said tulip contact extends at least in sections into said window or said depression.

15. The assembly according to claim 14, wherein two contact wings of said tulip contact extend into said window or into said depression from different sides of said stacking plate.

16. The assembly according to claim 14, wherein three contact wings of said tulip contact extend into said window or into said depression.

17. The assembly according to claim 14, wherein said plug-in connector is locked onto said stacking plate through assembly of said contact wings of the tulip contact in said window or in said depression.

18. The assembly according to claim 15, wherein said stacking plate is locked between said contact wings under prestressing.

19. The assembly according to claim 18, wherein a minimal spacing of said two contact wings in a prestress-free state is between 100%-250% of a plate thickness of said plug-in connector.

20. The assembly according to claim 14, wherein said plug-in connector is formed of a Cr—Ni stainless steel.

21. The assembly according to claim 14, wherein a length of a connection interface between a contact wing of said tulip contact and an adjacent sheet-metal plate of said plug-in contact is less than 50% of the length of a separation slot between a first contact wing and an adjacent contact wing.

22. The assembly according to claim 14, wherein said plug-in connector includes a sheet-metal plate having a contact protrusion.

23. The assembly according to claim 22, wherein said contact protrusion includes blocking wings for axially fixing a cladding.

24. The assembly according to claim 14, wherein said plug-in connector comprises a sheet-metal part having a tulip contact for contacting the stacking plate and a cladding made of a material which is dimensionally stable at 1000° C., wherein one single cladding is allocated to one sheet-metal part, respectively, for contacting a single stacking plate.

25. The assembly according to claim 23, wherein said blocking wings are arranged above or below a plate plane of said sheet-metal plate to fix said cladding.

26. The assembly according to claim 25, wherein a thickness of said sheet-metal plate is greater than 0.1 mm.

27. The assembly according to claim 14, wherein said stacking plate has a thickness of 0.7 mm+/−0.1 mm.

28. The assembly according to claim 21, wherein said contact wings have curves for locking onto said stacking plate, wherein said curves have radii of curvature which are arranged parallel and offset relative to one another along a longitudinal axis of said sheet-metal plate.

29. The assembly according to claim 21 wherein said contact wings have curves for locking onto said stacking plate, wherein said curves have radii of curvature which are situated on an axis perpendicular to a plate plane of said sheet-metal plate.
